(19) United States
(12) Patent Application Publication
(10) Pub. No.: US 2012/0250045 A1
(43) Pub. Date: Oct. 4, 2012

(54) PRINT SYSTEM

(75) Inventor: Atsushi UEMURA, Osaka (JP)

(73) Assignee: SHARP KABUSHIKI KAISHA, Osaka (JP)

(21) Appl. No.: 13/408,115

(22) Filed: Feb. 29, 2012

(30) Foreign Application Priority Data
Mar. 28, 2011 (JP) 2011-070062

(51) Int. Cl. G06K 15/02

(52) U.S. Cl. 358/1.9

(57) ABSTRACT

A print controller sets, in response to reception of an inquiry related to dimensions of unprintable area as an area not allowing printing of a document from a document data creating unit, dimensions of the unprintable area to default values or values smaller than the default values. The set dimensions of the unprintable area are notified to a document data processing unit, print data is formed based on data received from the document data processing unit and the dimensions of the unprintable area, and a print instruction is given to a printing device.

### CROSS-REFERENCE TO RELATED APPLICATION

This nonprovisional application claims priority under 35 U.S.C. §119(a) on Patent Application No. 2011-070062 filed in Japan on Mar. 28, 2011, the entire contents of which are hereby incorporated by reference.

### BACKGROUND OF THE INVENTION

1. Field of the Invention

The present invention relates to a print system and, more specifically, to a print system that can provide optimal result of printing when printing requires output paper size larger than original document size.

2. Description of the Background Art

When original document data is transferred from a device having a function of creating document data such as a computer to a printing device and the document is to be printed using the printing device, depending on the printing device, borderless printing is impossible. The borderless printing means printing of document data on a sheet of paper with no margin around the output sheet. Referring to FIG. 12, assume that document data is to be printed on a sheet of paper 252 having the same size as the paper size of a document 250. In some printing devices, a margin area 254 is set uniquely for the sheet of paper and, therefore, the document cannot be printed on the margin area. Thus, the document data is printed only in a printable area 256. In such a situation, it is possible to obtain the result of borderless printing by printing on a sheet of paper 258 larger than the paper size of document 250, and by cutting margin (unprintable area) 260 around a printable area 262, as shown in FIG. 13.

It is noted, however, that some applications for creating documents set margin area regardless of user's intension, based on margin area information received from a printer driver. In that case, even when the size of output paper is larger than the document paper size, the document forming area is unintentionally limited to an area of document paper size minus margin area, or portions corresponding to the margin area of the document data are made blank. Therefore, where the document data falls within such margin area, the document data in that area cannot be printed.

Such a situation will be described with reference to FIGS. 14 to 17. Referring to FIG. 14, on a document page setting screen image 270, a margin setting key 272 for setting margin values, a preview display 274 of the document, an OK key 276, and a cancel key 278 are displayed. The user operates margin setting key 272 to set each margin from a default value to 0, as shown in FIG. 15. In response to this operation, a preview with no margin is displayed on preview display 274.

When the user clicks OK key 276 with margin values set to 0, a warning message 290 such as shown in FIG. 16 appears. Warning message 290 says that with the margin values input by the user, appropriate printing of data is impossible and hence, margin values should be fixed. When the user clicks a fix key 292, margin values are changed to default values of the document creating application. Accordingly, preview display 274 comes to include the margins of the default values.

If the user clicks an ignore key 294, the margin values are kept set at 0, while in actual printing, document areas overlapping the margins are not printed, because of specification requirement of the printing device.

As a method of realizing printing with minimum margins, Japanese Patent Laying-Open No. 2007-272780 discloses a technique of printing a register mark, which is used as a reference when cutting sheets of paper, only on necessary sheets. This technique reduces possibility of register marks left after cutting and enables printing of document with as smaller margin as possible, than when the register marks are printed on all sheets of paper to be cut. The technique, however, is for solving the problem when a plurality of pages are printed on a sheet of paper and thereafter the sheet is cut, for example, for bookbinding, and it cannot solve the above-described problem encountered when borderless printing is to be done on a sheet of paper.

### SUMMARY OF THE INVENTION

Therefore, desirably, an object of the present invention is to provide a print system capable of borderless printing when output paper size is larger than document paper size.

According to a first aspect, the present invention provides a print controller used connected to a document data creating unit and to a printing device, including: an unprintable area setting unit, responsive to reception of an inquiry related to dimensions of unprintable area as an area not allowing printing provided around a sheet of print paper from the document data creating unit, for selectively executing a process for setting dimensions of the unprintable area of output paper having larger size than paper size of a document created by the document data creating unit to default values, and a process for setting the dimensions to values smaller than the default values; a notifying unit for giving a notice to the document data creating unit about the dimensions of the unprintable area set by the unprintable area setting unit; and a print instruction unit for forming print data based on data related to the document received from the document data creating unit and on the values of dimensions of unprintable area, and instructing the printing device to print the print data.

By the unprintable area setting unit, for the output paper having the size larger than the document paper size, the dimensions of unprintable area are selectively set to default values or to prescribed values smaller than the default values. Further, by the print instruction unit, the dimensions of the set unprintable area are reflected on the print data. Therefore, if the output paper has larger size than the document paper size, the dimensions of unprintable area can be changed from the default values. By such a setting that minimizes the unprintable area, borderless printing with very small margins to be cut becomes possible.

Preferably, the unprintable area setting unit includes a flag storage unit for storing a flag indicating whether or not output to output paper larger than paper size of the document created by the document data creating unit is prohibited or permitted, and a setting process selecting unit, responsive to reception of an inquiry related to the dimensions of unprintable area from the document data creating unit, for selectively executing a process for setting the dimensions of the unprintable area to the default values and a process for setting the dimensions to the prescribed values, based on a value of the flag stored in the flag storage unit.

When the document is to be printed on the output paper having larger size than the document paper size, the flag is turned on by the flag storage unit. The dimensions of unprintable area are selectively determined depending on whether the flag state is on or off. Therefore, if the user sets the flag on or off, the dimensions of unprintable area is automatically determined, and it is unnecessary for the user to set the unprintable area.

More preferably, the unprintable area setting unit includes a determining unit for determining, based on data related to the document, whether or not paper size of the output paper is larger than paper size of the document, and a setting process selecting unit for selectively executing a process for setting the dimensions of the unprintable area to the default values and a process for setting the dimensions to the prescribed values, based on a result of determination by the determining unit.

By the determination of determining unit as to whether or not the output paper size is larger than the document paper size, the dimensions of unprintable area are selected. Therefore, the dimensions of unprintable area are set to the prescribed values smaller than the default values only when the output paper size is larger than the document paper size and, hence, borderless printing can be done without print error.

More preferably, the print controller further includes a paper list holding unit for holding a paper list that can record a plurality of output paper sizes. The print instruction unit includes a paper list determining unit for determining whether or not paper of the type having larger size than the document paper size is included in the paper list held by the paper list holding unit; and a print process selecting unit for selectively executing a process for selecting output paper having larger size than the document paper size from the paper list and causing the printing device to print, and a process for suspending the print process, depending on the result of determination by the paper list determining unit.

By the print list determining unit and the print process selecting unit, the print process is executed if the paper of the type having larger size than the document paper size is included in the paper list, and otherwise, the print process is suspended. If there is a plurality of different paper sizes allowing printing of document data, the document data is printed on the output paper having larger size than the document paper size, without the necessity of confirming the paper size. In the absence of output paper having larger size than the document paper size, the printing process is suspended. Therefore, there is no possibility that printing is done on an output sheet of paper having smaller size than the document paper size, and the document data can reliably be printed on the output paper.

More preferably, the print controller further includes an output paper size setting unit for setting paper size of the output paper. The print instruction unit includes: a paper size determining unit for determining whether or not the document paper size both in lengthwise and widthwise directions fits into the paper size of the output paper set by the paper size setting unit; and a print process selecting unit for selectively executing a process for forming print data on a sheet of output paper and a process for suspending the print process, depending on the result of determination by the print size determining unit.

By the paper size determining unit and the print process selecting unit, the print process is executed when the paper size of the output paper is large enough to enclose the document paper size both in the lengthwise and widthwise directions. Therefore, regardless of the outer shape of document, the document does not run over from the output sheet of paper either in the lengthwise or widthwise direction, and the document as a whole can be printed on the output sheet of paper.

More preferably, the print controller further includes a paper size setting unit for setting the document paper size and the paper size of the output paper. The print instruction unit includes: a paper size matching determining unit for determining whether or not the document paper size set by the paper size setting unit matches the document paper size based on the data related to the document; and a print process selecting unit for selectively executing a process for forming print data on a sheet of output paper and a process for suspending the print process, depending on the result of determination by the paper size matching determining unit.

By the paper size setting unit, the paper size of document and the paper size of output paper are set in advance, prior to the print process. Further, if the preset paper size of the document does not match the paper size of the document based on the data related to the document, the print process is suspended. The user can set the document paper size in advance using the paper size setting unit. Further, since the print process is executed only when the setting by the user is reflected on the data related to the document by the print process selecting unit, printing as desired by the user can be realized.

More preferably, the print controller further includes a collective printing instruction unit for adding an instruction command to execute collective printing, to a print instruction given by the print instruction unit; wherein the unprintable area setting unit includes a determining unit for determining whether or not paper size of the output paper is larger than paper size of a plurality of documents arranged side by side, based on the data related to the document, and a setting process selecting unit for selectively executing a process for setting the dimensions of the unprintable area to the default values and a process for setting the dimensions to the prescribed values, based on a result of determination by the determining unit.

Depending on whether the paper size of the output paper is larger than the paper size of a plurality of documents arranged side by side, the dimensions of unprintable area are set to default values or prescribed values smaller than the default values. Therefore, even when collective printing is done, the dimensions of unprintable area can be changed from default values if the paper size of output paper is larger than the paper size of the plurality of documents arranged side by side. By such a setting that minimizes the unprintable area, borderless printing with very small margins to be cut becomes possible.

More preferably, the print controller further includes a paper list holding unit for holding a paper list that can record a plurality of output paper sizes. The print instruction unit includes: a paper list determining unit for determining whether or not the paper list held by the paper list holding unit includes paper having larger size than the paper size of a plurality of documents arranged side by side; and a print process selecting unit for selectively executing a process for selecting output paper having larger size than the paper size of a plurality of documents arranged side by side from the paper list and causing the printing device to print, and a process for suspending the print process, depending on the result of determination by the paper list determining unit.

By the paper list determining unit and the print process selecting unit, the print process is realized when the output paper size is larger than the paper size of a plurality of documents arranged side by side. Therefore, even when there is a plurality of different sizes of output paper, printing is not done unless there is a sheet of output paper having larger size than the paper size of a plurality of documents arranged side by side and, therefore there is no possibility of printing the document running over from the output paper.

More preferably, the print controller further includes an output paper size setting unit for setting paper size of the output paper. The print instruction unit includes: a paper size determining unit for determining whether or not the paper size of a plurality of documents arranged side by side both in lengthwise and widthwise directions fits into the paper size of the output paper set by the paper size setting unit; and a print process selecting unit for selectively executing a process for forming print data on a sheet of output paper and a process for suspending the print process, depending on the result of determination by the print size determining unit.

By the paper size determining unit and the print process selecting unit, the print process is executed only when it is determined that the paper size of the output paper is large enough to enclose the document paper size of a plurality of documents arranged side by side both in the lengthwise and widthwise directions. Therefore, in collective printing also, printing is possible with the document not running over from the output sheet of paper either in the lengthwise or widthwise direction.

More preferably, the print controller further includes a paper size setting unit for setting the document paper size and the paper size of the output paper. The print instruction unit includes: a paper size matching determining unit for determining whether or not the document paper size set by the paper size setting unit matches the document paper size based on the data related to the document; and a print process selecting unit for selectively executing a process for forming print data on one half of a sheet of output paper and a process for suspending the print process, depending on the result of determination by the paper size matching determining unit.

It is possible for the user to set the paper size of document and paper size of output paper by the paper size setting unit. Further, by the paper size matching determining unit and the print process selecting unit, the print process is executed only when the preset paper size of the document matches the document paper size based on the data related to the document. Therefore, even in collective printing, the print process is executed only when the setting by the user on the data related to the document is reflected, and printing with the paper size desired by the user become possible.

More preferably, the pint controller further includes a collective printing executing unit for executing an instruction for collective printing issued by the collective printing instruction unit.

By the collective printing executing unit, collective printing is executed by the pint controller. Therefore, collective printing by the print controller is possible without necessitating any special operation by the user.

More preferably, the print controller further includes a collective printing execution instruction unit causing the document data creating unit to execute the instruction of collective printing instructed by the collective printing instruction unit.

By the collective printing execution instruction unit, collective printing by the document data creating unit is executed. Since this execution instruction is automatically issued by the print controller, it is unnecessary for the user to perform any special operation in executing the collective printing.

More preferably, the print controller further includes a setting notification unit for giving a notice that dimensions of unprintable area have been set, in response to setting of the dimensions of unprintable area by the unprintable area setting unit.

Since the notice that dimensions of unprintable area have been set is given, the user can recognize whether or not the dimensions of the set unprintable area are of default values before printing. Further, if the dimensions of unprintable area are not the default values, the user can edit the document data in accordance with the set dimensions.

According to a second aspect, the present invention provides a communication device used connected to an external printing device, including: a document data creating unit; and the print controller according to the first aspect, connected to the document data creating unit and the printing device.

The document data creating unit and the print controller in the communication device realize the print control such as described above on the external printing device. Therefore, when the communication device is connected to an external printing device, it becomes possible to additionally provide control for executing borderless printing of document data to be printed by the printing device.

According to a third aspect, the present invention provides a method of print control, for controlling, in a process of forming print data on output paper based on data related to a document created by a document creating application, on the data related to the document, including the steps of: receiving, from the document creating application, an inquiry related to dimensions of an unprintable area not allowing printing of the document, provided around printing paper; selectively executing the step of setting dimensions of the unprintable area of output paper having larger size than the paper size of the document to default values and the step of setting the dimensions to values smaller than the default values; returning the dimensions of the unprintable area to the document creating application; and transmitting print data formed based on already set dimensions of the unprintable area and on the data related to the document, to a printing device.

By the method of print control, if the output paper size is larger than the document paper size, the dimensions of unprintable area are selected to be default values or prescribed values smaller than the default values. Therefore, by such control that minimizes the unprintable area, borderless printing with very small portions to be cut becomes possible.

As described above, by the present invention, if the output paper size is larger than the document paper size, the unprintable area can be changed from default values. Therefore, printing with the printing area of the document not overlapping the unprintable area becomes possible. Since setting of the unprintable area is automatically done by the print controller, it is possible for the user to have borderless printing of a document simply by a usual print procedure.

Further, it is also possible to set the paper size of output paper to be always lager than the document paper size. If such setting as described above is done on the data related to the document, borderless printing is executed in accordance with the setting. The setting may be done in various manners. For example, the setting may be to select an output sheet of paper of an appropriate size from a plurality of sheets of output paper having larger size than the document paper size, or the setting may be to enclose the output document within the output paper size both in the lengthwise and widthwise directions.

By the present invention, when collective printing is to be done and the output paper size is larger than the document paper size, the unprintable area can be changed from the default size. In this case also, as in the examples above, setting of the unprintable area is automatically done by the print controller. Further, the setting may be done in various manners. For example, the setting may enable two documents arranged side by side to be printed within a sheet of output paper.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an exemplary configuration of a print system in accordance with an embodiment of the present invention.

FIG. 2 is a functional block diagram of a computer included in the print system shown in FIG. 1.

FIG. 3 is a flowchart representing a control structure of a program related to a first embodiment.

FIG. 4 is a flowchart representing a control structure of a program related to a second embodiment.

FIG. 5 is a flowchart representing a control structure of a program related to a third embodiment.

FIG. 6 is a flowchart representing a control structure of a program related to a fourth embodiment.

FIG. 7 is a flowchart representing a control structure of a program related to a fifth embodiment.

FIG. 8 is a flowchart representing a control structure of a program related to a sixth embodiment.

FIG. 9 is a flowchart representing a control structure of a program related to a seventh embodiment.

FIG. 10 is a flowchart representing a control structure of a program related to an eighth embodiment.

FIG. 11 is a flowchart representing a control structure of a program related to a ninth embodiment.

FIG. 12 shows an example in which document data is printed on a sheet of paper having the same size as the paper size of the document data.

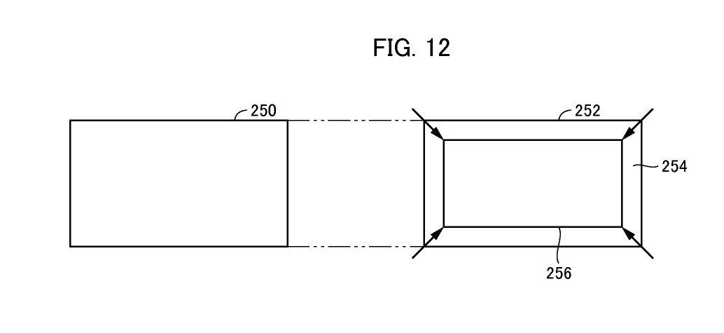

FIG. 13 shows an example in which document data is printed on a sheet of paper having a larger size than the paper size of the document data.

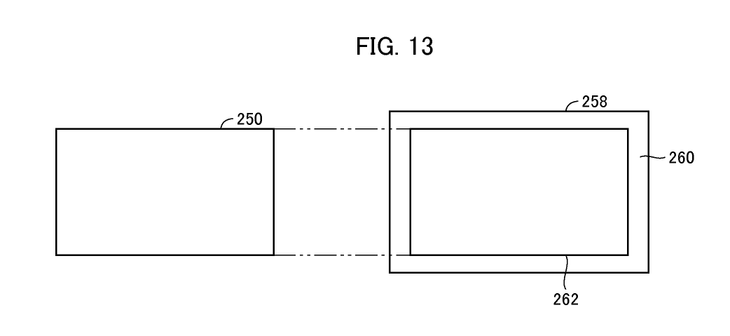

FIG. 14 shows an initial screen image for page setting displayed on a computer.

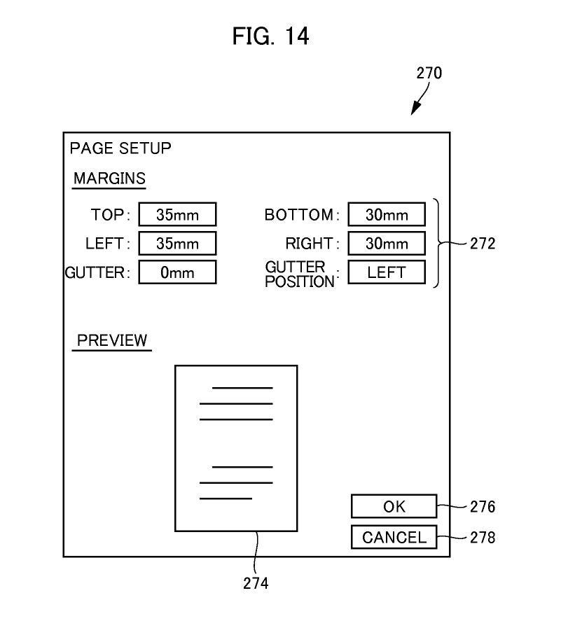

FIG. 15 shows changes to the margin values on the initial screen image shown in FIG. 14.

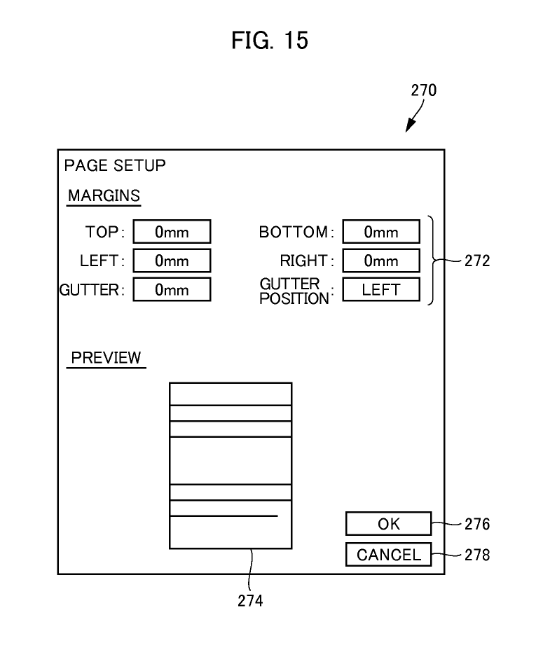

FIG. 16 is an alarm display screen image giving an alarm that the set margin is in the unprintable area.

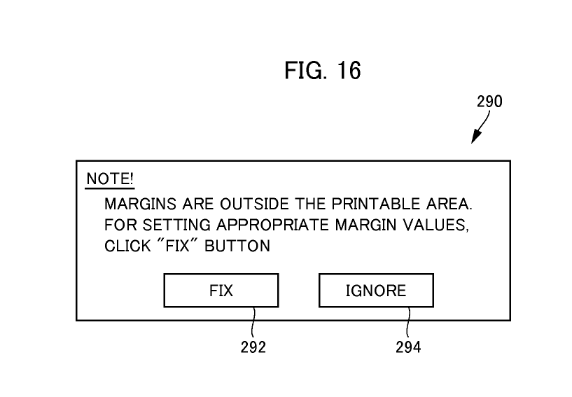

FIG. 17 shows the margin values shown in FIG. 15 fixed by the computer.

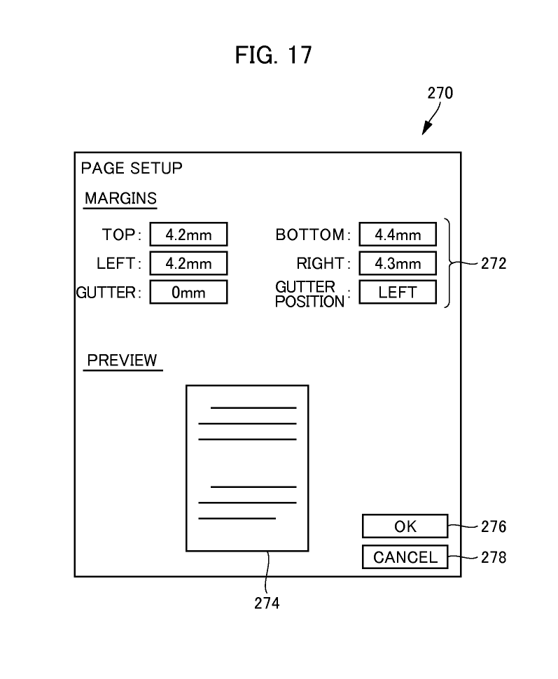

FIG. 18 is a screen image for paper setting, displayed on the computer.

FIG. 19 illustrates collective printing in accordance with an embodiment.

FIG. 20 illustrates paper size when two documents are arranged side by side.

FIG. 21 illustrates two documents collected on one sheet of paper.

FIG. 22 illustrates four documents collected on one sheet of paper.

FIG. 23 shows sixteen documents collected on one sheet of paper.

### DESCRIPTION OF THE PREFERRED EMBODIMENTS

In the following description, the same components are denoted by the same reference characters. Therefore, detailed description thereof will not be repeated. Similarly, when the same process takes place in different embodiments, detailed description thereof will not be repeated.

### First Embodiment

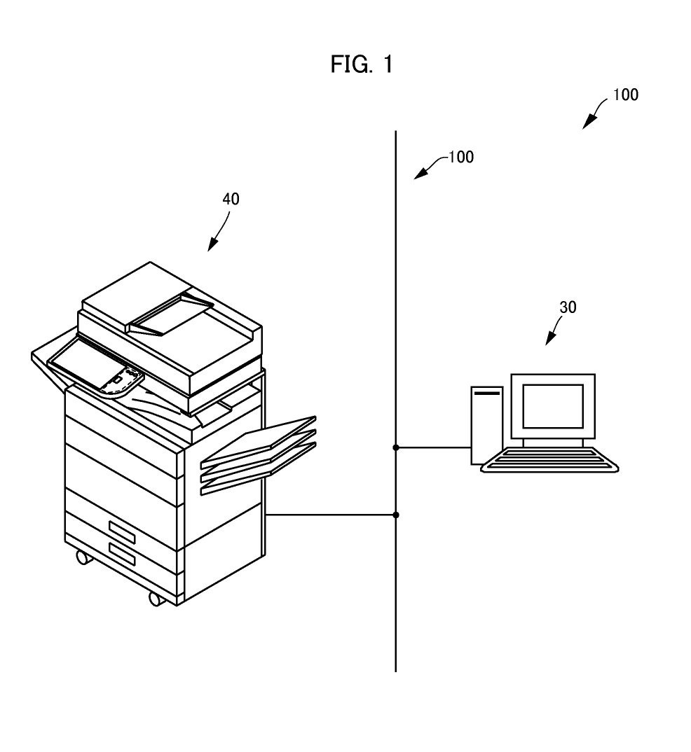

Referring to FIG. 1, a print system 100 in accordance with the present embodiment includes a computer 30 having a document creating function, a printing device 40 and a network 50. The computer is capable of executing a document creating application as will be described later. It is possible for the user by operating the document creating application to create document data and to give a print instruction. Computer 30 and printing device 40 are connected through network 50. In response to a print instruction from computer 30, printing device 40 prints received document data.

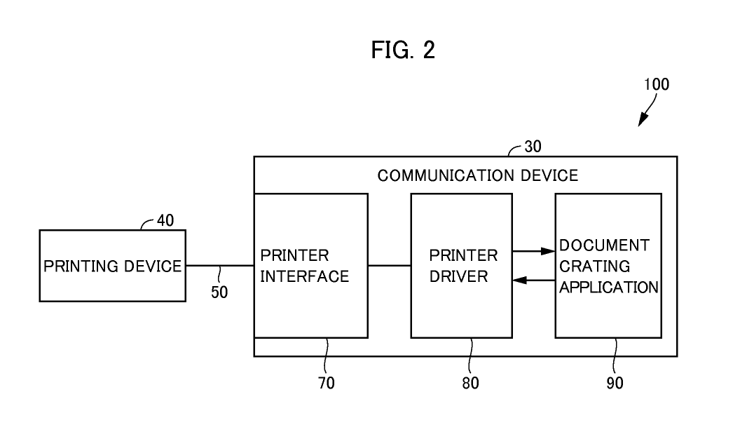

Referring to FIG. 2, computer 30 includes a printer interface 70 connecting computer 30 to printing device 40 through network 50. Further, computer 30 executes a printer driver 80 controlling printing device 40 and a document creating application 90 that creates document data and issues a print instruction. Printer drive 80 controls the printing device in accordance with a request from document creating application 90.

In the prior art, document creating application 90 issues all instruction commands related to document data such as format, and based only on the instruction commands, the print data are formed. In the print system in accordance with the present embodiment, printer driver 80 performs a prescribed operation based on contents of instruction or instructions from document creating application 90, and realizes printing of document data even on the area that has been handled as margin area. The paper size for printing a document includes two different types, that is, a document paper size set by document creating application 90, and an output paper size the printer driver actually instructs to the printing device. In the present embodiment, when borderless printing is to be done, the document paper size is compared with the output paper size, and behavior of the printer driver is changed with respect to the document creating application and, only if prescribed conditions are satisfied, borderless printing becomes possible.

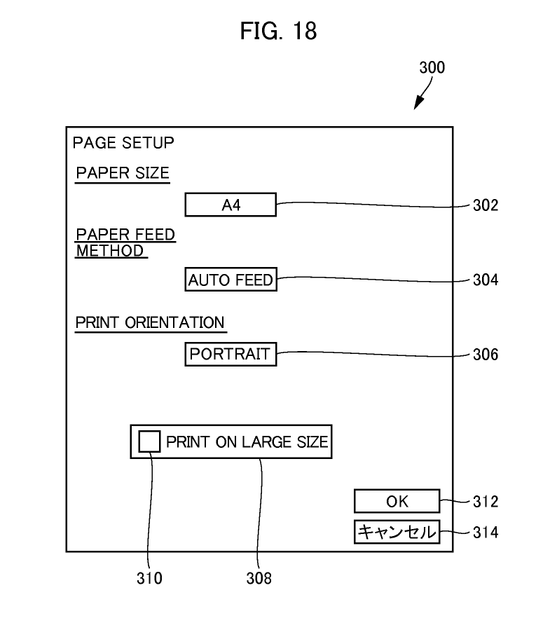

Referring to FIG. 18, the user may set various settings related to printing paper, on a paper setting screen image 300. On paper setting screen image 300, a paper size setting key 302, a paper feed method setting key 304, a print direction setting key 306, an OK key 312, a cancel key 314 and a large size setting section 308 are displayed.

Large size setting section 308 includes a check box 310. When OK key 312 is clicked with the check box checked, the printer driver is set to allow printing of a document on a sheet of paper having larger size than the paper size of document data. Printing with this setting will be hereinafter referred to as “large size printing.” In response to checking of check box 310, a flag of large size printing is set valid. Here, the dimensions of unprintable area surrounding the edge of the sheet of paper are set to prescribed values smaller than original default values. Specifically, in the present embodiment, the dimensions of unprintable area are set to 0. The user or one or a plurality of administrators may be authorized to set large size printing.

If check box 10 is not checked, the large size printing flag is invalid. The printer driver determines the paper size of output paper based on the paper size of document data set by document creating application 90. The dimensions of unprintable area around the sheet of paper are set to the original default values. Information related to the large size printing flag is saved by printer driver 80.

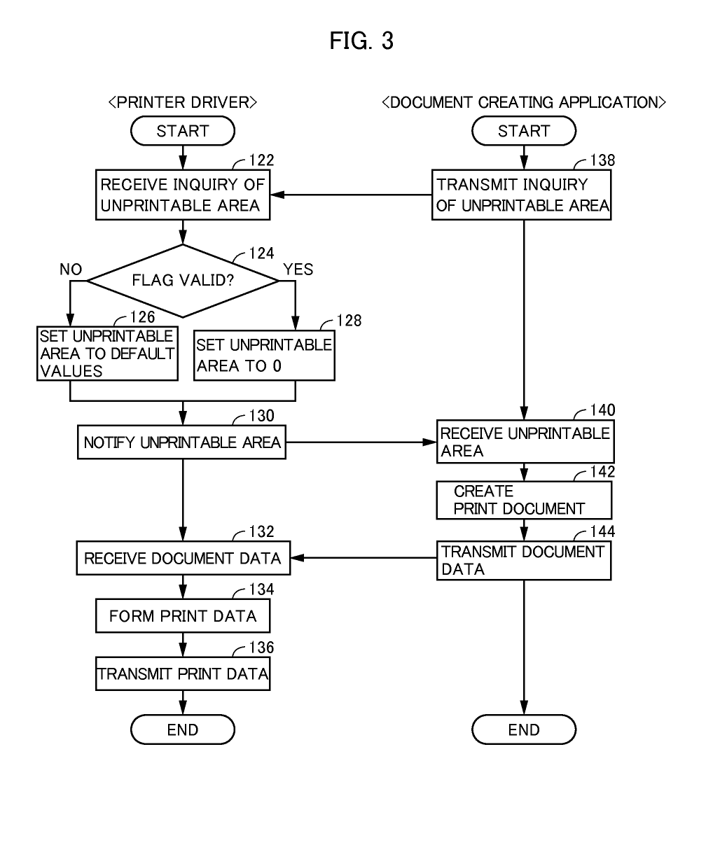

Referring to FIG. 3, a control structure of a program executed by the printer driver and the document creating application in accordance with the present embodiment will be described. When document creating application 90 is activated, when an operation is done to instruct change of paper size of the document data, or when the user makes an operation to change the printing device, document creating application 90 passes information related to paper size of document data that is being created or newly created document data to printer driver 80. Further, document creating application 90 transmits to printer driver 80 an inquiry related to paper margin to be set by printer driver 80, that is, an inquiry as to how large the unprintable area is (step 138).

In response to reception of the inquiry related to the unprintable area, printer driver 80 determines whether or not the large size printing flag described above is valid (step 124). If the result is negative, the flow proceeds to step 126, at which the values of unprintable area defined by document creating application 90 are set. If the result is positive, the flow proceeds to step 128, at which the values of unprintable area are set to 0.

After step 126 or step 128, the flow proceeds to step 130, at which printer driver 80 notifies document creating application 90 of the set values of the unprintable area. At step 140, document creating application 90 receives this notice and, based on the received values of unprintable area, sets a printable area and creates a print document (step 142). The print document is created based on a user operation. The created document data is transmitted to printer driver 80 at step 144, and printer driver 80 receives the document data (step 132). When step 144 ends, execution of the program controlling document creating application 90 ends.

On the side of the printer driver, at step 134, print data is formed based on the received document data. The print data includes information related to the size of output paper on which the document is to be printed. The output paper size may be set by the user using a user interface. The formed print data is transmitted to printing device 40 at step 136, and execution of the program controlling printer driver 80 ends.

In the print system in accordance with the present embodiment, if the large size print flag is valid, that is, if the paper size of output paper is larger than the paper size of document data, it is possible to set values of unprintable area to 0. Therefore, if the setting of large size print is set valid, printing in full document size on a sheet of output paper larger than the document paper size becomes possible and, thereafter, surrounding portions may be cut to realize borderless printing. If the flag is invalid, the unprintable area is of default values set by the document creating application. Therefore, on the printed sheet of output paper, prescribed blank portion remains around the document.

### Second Embodiment

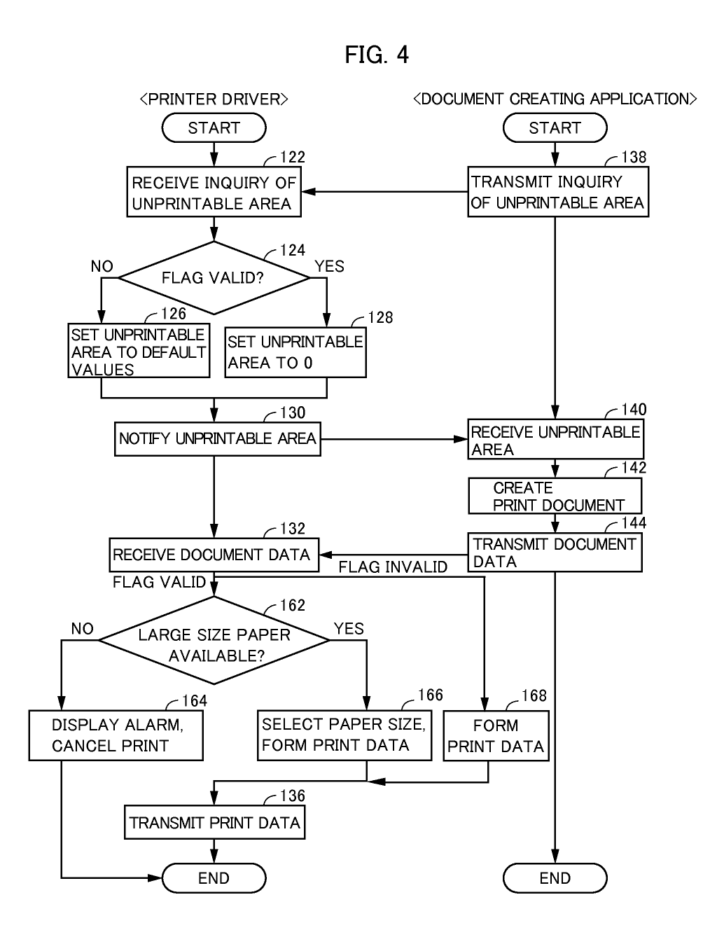

The present embodiment is characterized in that when borderless printing is to be realized, a sheet of output paper having a size larger than the paper size of document data and of the smallest size among sheets of paper allowing printing by the printing device is automatically selected and printing is done thereon. The flowchart shown in FIG. 4 is different from that of FIG. 3 in that in place of step 134 shown in FIG. 3, it includes steps 162 to 168 executed following step 132, of determining whether or not there is a paper of a size larger than the document size set by the document creating program among the sheets of paper allowing printing by the printing device, and executing an appropriate process depending on the result of determination. As to the flow after step 162, only an example when printing is done on a sheet of output paper larger than the document size will be described, for easier understanding. The same applies to other embodiments that follow.

Referring to FIG. 4, by the determination at step 124, if the large size print flag is determined to be valid, the control proceeds to step 162, and if the flag is determined to be invalid, the control proceeds to step 168. If the large size print flag is valid, at step 162, the printer driver determines whether or not there is a sheet of paper that encloses the received document data both in the lengthwise and widthwise directions among a paper list held by the printer driver. By way of example, if the paper size of document data is A4, whether or not a sheet of paper larger than the paper size of document data such as a B4 size or A3 size sheet of paper is in the paper list indicating types of paper printable by the printing device, is determined. If the result of determination is negative, the flow proceeds to step 164, at which an alarm image, not shown, is displayed and printing is cancelled. After the end of step 164, execution of the program ends.

If the result of determination at step 162 is positive, the flow proceeds to step 166. The printer driver selects, from the paper list indicating types of paper printable by the printing device, a sheet of paper having the size closest to the paper size of document data (that is, the smallest size) that can enclose the document data both in the lengthwise and widthwise directions. Based on the selection, print data is formed, and then, control proceeds to step 136, at which the print data is transmitted to the printing device. After the end of step 136, execution of the program ends. If the flag is invalid, at step 168, print data is formed in accordance with settings preset by the document creating application. Then, the control proceeds to step 136, and execution of the program ends.

In the print system in accordance with the present embodiment, after receiving the document data from the document creating application, the printer driver determines whether or not a sheet of paper having the size larger than the paper size of document data is included in the paper list indicating types of paper printable by the printing device. If paper of larger size exists, a sheet of paper having the size closest to the size of document data (that is, paper of smallest size) among the list is selected, the print data is formed, and printing is executed. If such paper is not included in the list, the print operation is cancelled. Therefore, the user can have borderless printing of document data without print error, and the print is of the size as close as possible to the paper size of the document data. As a result, wasteful consumption of large paper can be prevented.

### Third Embodiment

The present embodiment is characterized in that output paper size can be set on the side of printer driver, and that upon reception of an inquiry related to the unprintable area from the document creating application, if the large size flag is valid, the values of unprintable area are set to 0 for a document of paper size smaller than the set output paper size.

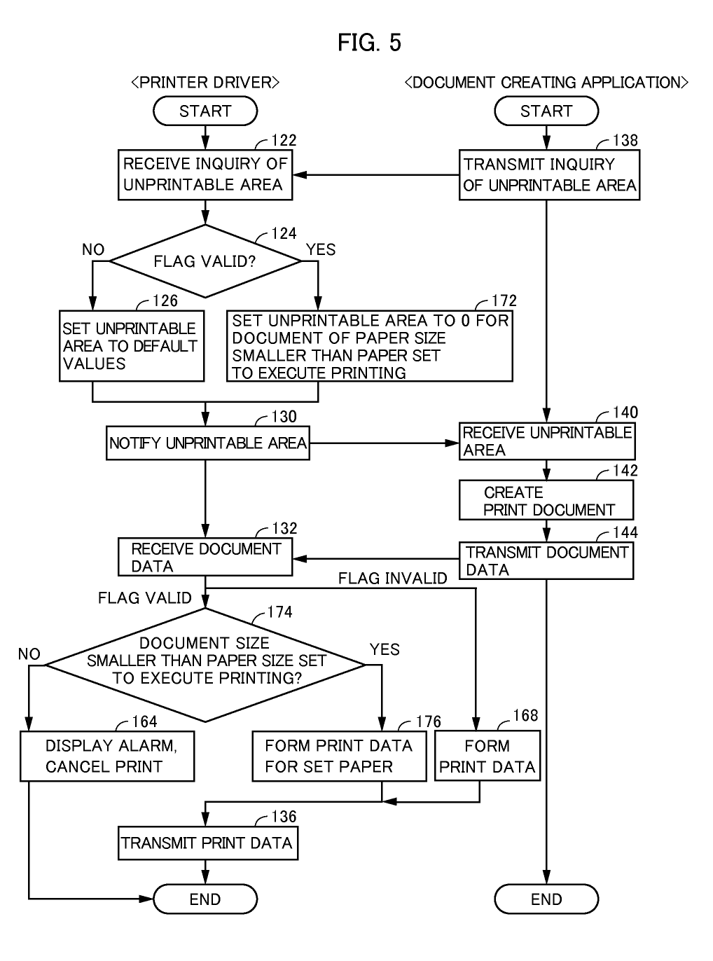

The flowchart shown in FIG. 5 is different from that of FIG. 4 in that in place of step 128 shown in FIG. 4, it includes a step 172 executed if the determination at step 124 is positive, of setting unprintable area to 0 for the paper having larger size than the document paper size. Further, it is different in that it includes, in place of steps 162 and 166 shown in FIG. 4, a step 174, following step 132, of determining whether or not the document size is smaller than the preset output paper size, and a step 176, executed if the determination at step 174 is positive, of forming print data such that printing is done on the output paper of preset size. When the process of step 176 ends, the process proceeds to step 136, and thereafter, execution of the program ends. On the other hand, if the determination at step 174 is negative, the process of step 164 is executed, as in the case of FIG. 4.

At step 172, the printer driver sets the values of unprintable area to 0 for the document having the paper size smaller than the preset output paper size. If the determination at step 124 is positive, the process of step 126 is executed as in FIG. 4, and default values of unprintable area are set for each paper size.

Therefore, when the document paper size is set by the document creating application, if the document size is smaller than the output paper size set in advance in the printer driver, by setting the unprintable area to 0, setting for borderless printing can be realized. On the other hand, if the document size is not smaller than the set output paper size, the values for the unprintable area are set to default values, and borderless printing is impossible.

After the printer driver receives the document data from the document creating application (step 132), the printer driver determines whether or not the paper size of the received document data is within the preset output paper size both in the lengthwise and widthwise directions, at step 174. If the paper size of the document data is smaller than the preset output paper size, the document can be printed on the set output paper. Therefore, in such a case, the control proceeds to step 176, and print data are formed such that the document is printed in the document paper size, on a sheet of output paper of the preset paper size. Thereafter, the control proceeds to step 136, and execution of the program ends. If the result of determination of step 174 is negative, the control proceeds to step 164, and thereafter, execution of the program ends.

In the print system in accordance with the present embodiment, the output paper size in the printing device is set in advance by the printer driver. If the document paper size is smaller than this output paper size, upon reception of an inquiry as to the unprintable area from the document creating application, the values for unprintable area are set to 0 if the flag is valid. Therefore, setting of borderless printing becomes possible. Further, printing is possible only when the document paper size is within the preset output paper size, and otherwise, printing is cancelled. Therefore, borderless printing is possible without wasting paper.

### Fourth Embodiment

As in the third embodiment, the print system in accordance with the present embodiment allows setting of output paper size in advance in the printer driver, and in addition, allows setting of document paper size. As a result, the setting of large size printing in accordance with the above-described embodiments becomes unnecessary. Such characteristics are realized by comparing the paper size of document data with the preset size of output paper and by setting values of unprintable area based on the result of comparison.

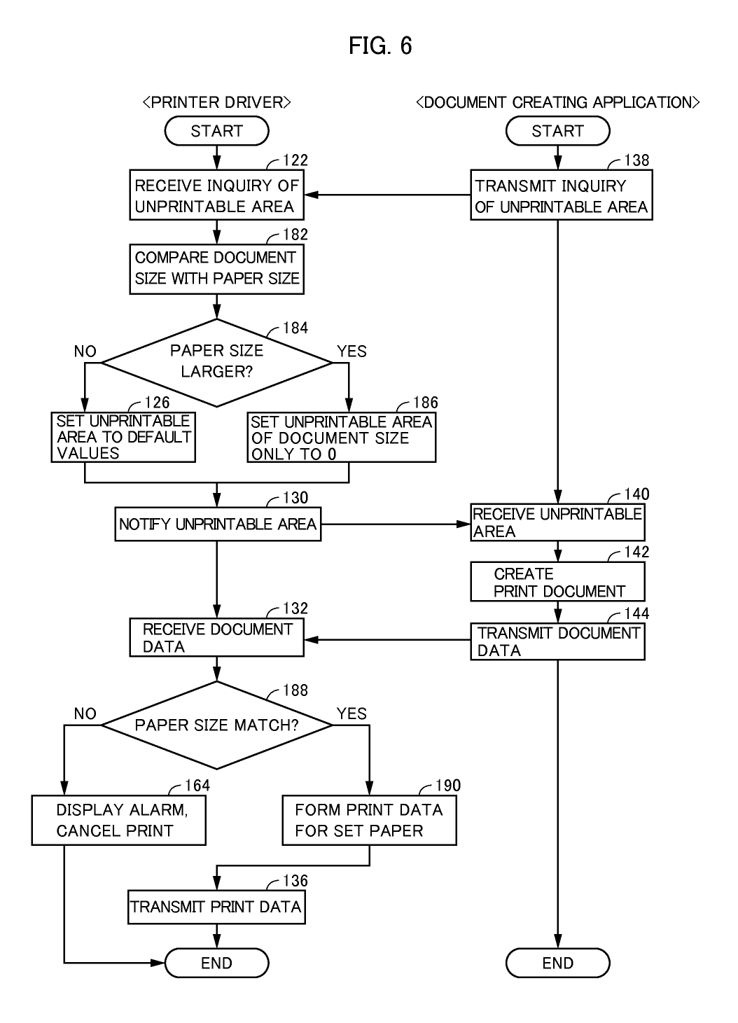

The flowchart shown in FIG. 6 is different from the flowchart shown in FIG. 5 in that it additionally includes a step 182, executed following steps 122, of comparing the set paper size of the document with the size of output paper, in place of step 124 shown in FIG. 5, it includes a step 184 of branching the control flow depending on whether or not the output paper size is larger, and it includes a step 186, executed if the determination at step 184 is positive, of setting only the unprintable area of the preset document size to 0 and proceeding to step 130. If the determination at step 184 is negative, the control proceeds to step 126.

Further, the flowchart shown in FIG. 6 is different from FIG. 5 in that in place of steps 174 and 176 shown in FIG. 5, it includes a step 188, following step 132, of determining whether the document paper size set beforehand and held inside the printer driver matches the paper size of document data transmitted from the document creating application, and a step 190, executed if the determination at step 188 is positive, of forming print data such that the document data is printed on the preset output paper and proceeding to the process of step 136.

In the print system in accordance with the present embodiment, the document paper size and the output paper size are set in advance in the printer driver. Upon reception of an inquiry related to the unprintable area from the document creating application, the printer driver compares the set document paper size with the output paper size, and if the output paper size is larger, sets the values for the unprintable area of the paper having the same size as the document data held in the printer driver to 0. By selecting the document paper size and the output paper size on the printer driver in advance, it is possible for the user to have borderless printing without print error.

### Fifth Embodiment

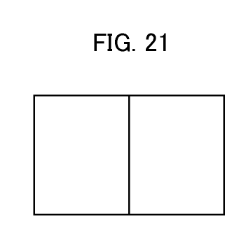

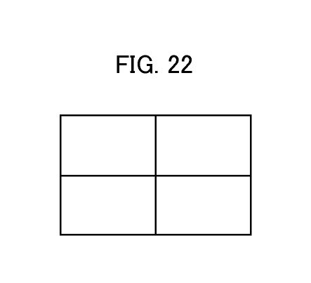

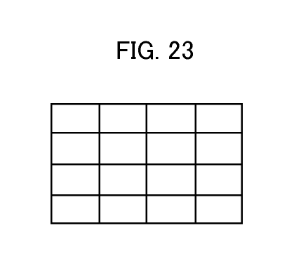

The present embodiment has a configuration similar to that of the first embodiment, and characterized in that borderless printing is possible when collective printing is set. The collective printing refers to a method of printing in which images of a plurality of pages are collectively printed on one sheet of paper. Currently available printing devices include ones having a function of arranging document data suitable for the collective printing as mentioned above and printing, when document data including a series of pages is applied with an instruction of collective printing. Referring to FIGS. 21 to 23, the number of images to be collected on one sheet of paper may be set arbitrarily by the user, by an operation on a collective printing setting screen image (not shown). FIG. 21 shows collection of two images, FIG. 22 of four images, and FIG. 23 of sixteen images, respectively, on a sheet of paper. The present embodiment allows borderless printing in such a printing device. Typically, setting of collective printing is done by a setting dialog of the printer driver.

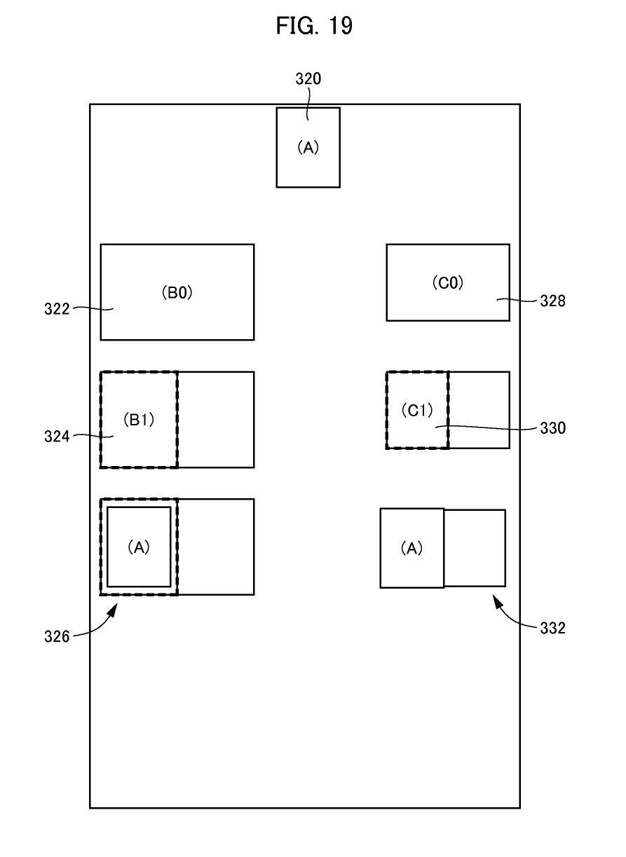

In the following, referring to FIG. 19, consider collective printing of document 320 on each of sheets of output paper 322 and 328 having different sizes. For simplicity of description, it is assumed that document images of two pages are collectively printed on a sheet of paper. Even if the number of images to be collectively printed is larger than 2, the operation is similar to that described in the following.

A part 324 of output sheet is one-half of output paper 322 cut at a cutting line that connects midpoints of two opposite longer sides. When a document 320 is placed on the part 324 of output sheet, a superposition 326 results. Since the part 324 of output paper is larger both in lengthwise and widthwise directions than document 320, document 320 does not run over from the part 324 of output paper. In the present embodiment, since the document data can be printed within the output paper in such a situation, the values of unprintable area are set to 0.

A part 330 of output paper is also a part of output sheet 328 also cut into half size, as the part 324 of output paper described above. When document 320 is placed on the part 330, a superposition 332 results. Since the part 330 is smaller than document 320 both in the lengthwise and widthwise directions, document 320 runs over from the part 330 of output paper. In the present embodiment, since the document would be printed fully on the entire surface of output paper in such a situation, the values of unprintable area are set to default values.

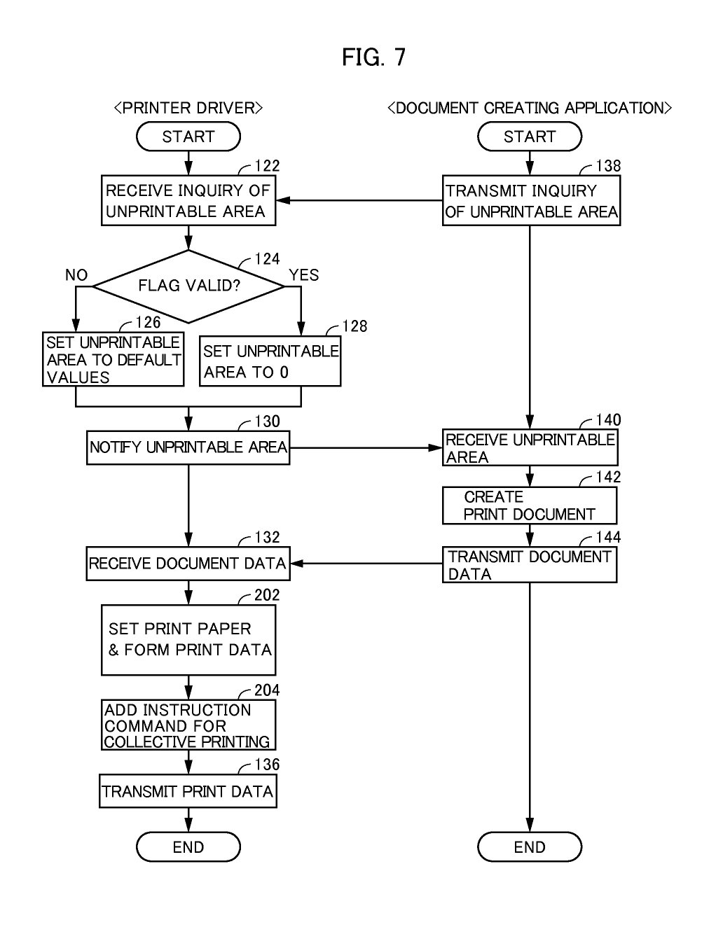

FIG. 7 shows, in a flowchart, a control structure of the printer driver and the document creating application for realizing the print system in accordance with the present embodiment. The flowchart shown in FIG. 7 is different from the flowchart shown in FIG. 3 in that it includes, in place of step 134 of FIG. 3, a step 202, following step 132, of setting output paper size and forming print data, and a step 204, following step 202, of adding an instruction for collective printing to the print data formed at step 202 and passing the control to the process of step 136.

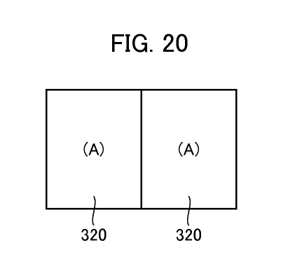

At step 202, the printer driver sets, as output paper, a sheet of paper having a size larger than the size of paper corresponding to two documents arranged side by side with the longer sides abutting with each other (see FIG. 20), and forms print data. Setting of paper size may be directly done by the user using a printer interface. At step 204, an instruction command related to collective printing is added to the formed print data, so that collective printing is executed by the printing device. Thereafter, the flow proceeds to step 136 and, then, execution of the program ends.

In the print system in accordance with the present embodiment, if the flag is valid and the paper size of output paper is larger than the paper size of document data, the values of unprintable area of document data are set to 0. Further, an instruction command for executing collective printing is added to the print data at the time of print execution. Therefore, even when collective printing is done, the document data is printed not running over the printable area of the output paper and, hence, the user can obtain borderless printing.

### Sixth Embodiment

The present embodiment is characterized in that borderless printing is possible even when collective printing is set, and that sheet of output paper of appropriate size is selected and borderless printing is done only when output paper having the size larger than twice the paper size of document data is available.

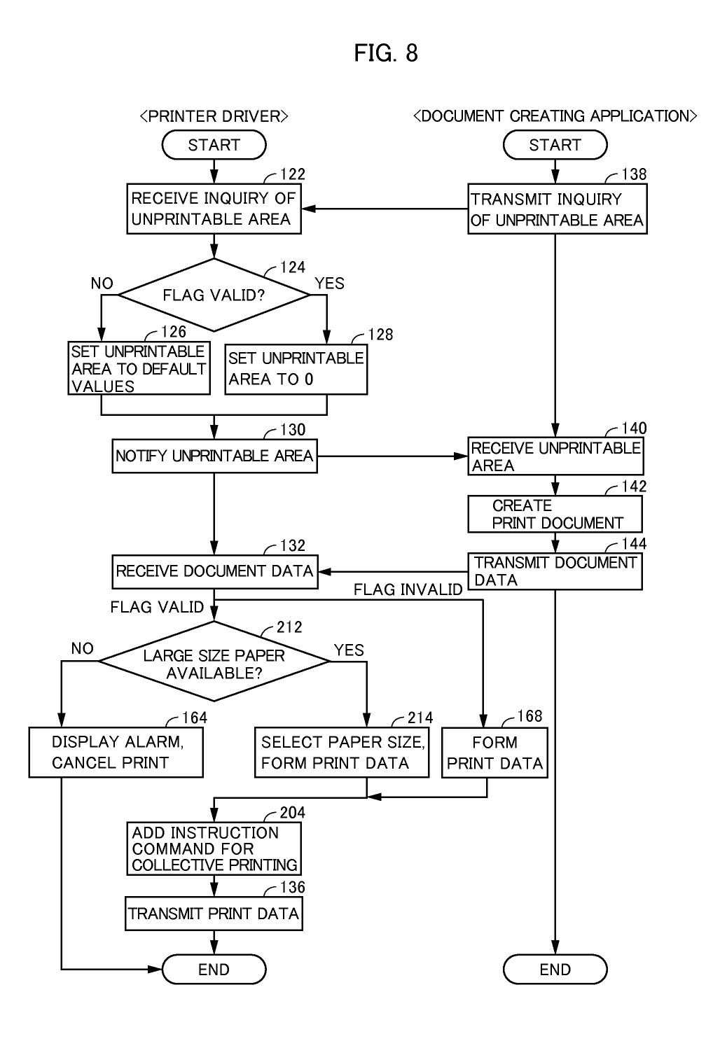

Though the flowchart shown in FIG. 8 is similar to that of FIG. 7, it is different in that it includes, following step 132, a step 212 of determining, when the large size print flag is valid, whether or not paper having larger size than twice the size of document data is included in the afore-mentioned paper list, a step 164 of displaying an alarm if the determination at step 212 is negative, and cancelling printing, a step 214, executed if the determination at step 212 is positive, of selecting an appropriate output paper size, forming print data, and passing control to step 204, and a step 168, executed if the large size print flag is invalid, of forming print data based on settings made in advance on the document creating application.

If the large size print flag is valid, at step 212, the printer driver determines whether or not output paper having a size larger than the paper size corresponding to two document data placed side by side is included in the output paper list held in the printer driver. At step 214, a paper size larger than and closest to (that is, smallest) the paper size corresponding to the two document data placed side by side is selected as the output paper size, and the print data is formed. If the large size print flag is invalid, at step 168, the printer driver forms print data based on settings made in advance on the document creating application.

In the print system in accordance with the present embodiment, if the paper size of printing paper is larger than the paper size of document data, the values of unprintable area of the document data are set to 0. Further, upon reception of document data, print data is formed only if the output paper size larger than the size of two documents arranged side by side is available. An instruction command to execute collective printing is added to the print data. Therefore, even when collective printing is done, the document data is printed not running over the printable area of the output paper and borderless printing is possible. As the output paper size, minimum size necessary for the borderless printing is selected. Therefore, wasteful use of an unnecessarily large paper can be avoided.

### Seventh Embodiment

In the present embodiment, as in the first and second embodiments, the large size print flag is used. Further, the embodiment is characterized in that the values of unprintable area are set to 0 only when the paper size of document data is within half the size of set output paper.

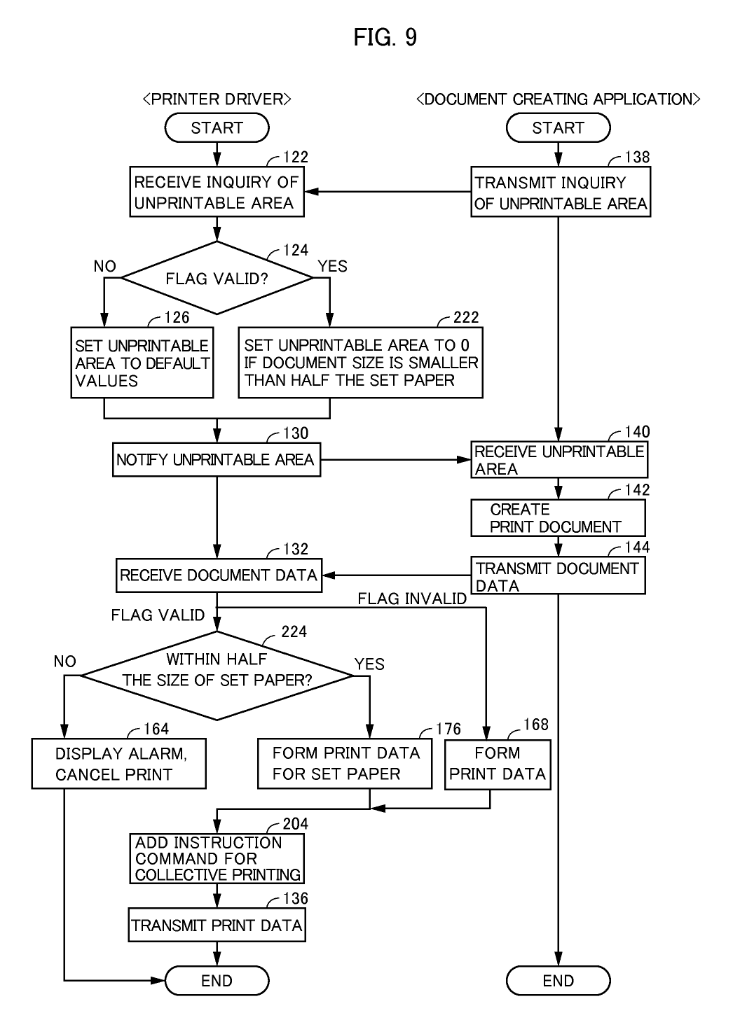

Though the flowchart shown in FIG. 9 is similar to that of FIG. 8, it is different in that it includes, in place of step 128 shown in FIG. 8, a step 222, executed if the result of determination at step 124 is positive, of setting values of unprintable area of document size smaller than half the size of output paper set in advance in the printer driver to 0, and in place of steps 212 and 214 of FIG. 8, respectively, a step 224 of determining whether or not the received document data are within half the size of output paper already set in the printer driver both in the lengthwise and widthwise dimensions, and a step 176 of forming print data to print the document on the output paper set in advance in the printer driver and passing the control to step 204. As in the flow of FIG. 8, at step 124, if the large size print flag is determined to be valid, the control proceeds to step 224 and if it is determined to be invalid, the control proceeds to step 168, and if the determination at step 224 is negative, the control proceeds to step 164.

At step 222, the printer driver determines the size of output paper obtained by cutting the paper of already set output paper size along a line connecting midpoints of two opposite longer sides, and for the document size smaller than this size of output paper (that is, within this size both in the lengthwise and widthwise directions), sets the values of unprintable area to 0.

As such values of unprintable area are received at step 140, on the side of document creating application, if the large size print flag is on, the dimensions of unprintable area can be set to 0 if the document size is smaller than half the set size of output paper and, as a result, borderless printing is possible. For other document size, default values of the printing device are set as the dimensions of the unprintable area and, therefore, borderless printing is impossible.

At step 224, whether or not the paper size of document data is smaller than half the size of output paper set in advance in the printer driver (within half the size both in lengthwise and widthwise directions) is determined. If the result is negative, the control proceeds to step 164, at which an alarm is given, printing is not done and execution of the program ends. If the result is positive, the control proceeds through steps 176, 204 and 136, so that printing for collective printing of document data is done on the output paper of the size set in advance in the printer driver.

In the print system in accordance with the present embodiment, if the large size print flag is on and the paper size of document data is smaller than half the size of output paper already set in the printer driver, setting of borderless printing is possible on the side of document creating application. If the document data is passed from the document creating application to the printer driver and the document paper size is within half the output paper size already set in the printer driver, the document is printed in the collective manner. Therefore, borderless printing can be done while the document data are not positioned over the margin at the center of the page at the time of collective printing.

### Eighth Embodiment

Though borderless printing is possible in the present embodiment, the large size print flag is not used. In the present embodiment, the paper size of document data and the size of output paper can be set in advance in the printer driver. According to the present embodiment, receiving an inquiry related to the unprintable area from the document creating application, the printer driver compares the already set paper size of document data with half the already set output paper size, and based on the result of comparison, determines whether or not the values of unprintable area are to be set to 0. The document creating application sets document printing based on the values of the unprintable area. The printer driver is characterized in that, when the document data is received from the document creating application, it determines whether or not the preset document paper size matches the document paper size of the received document data, and determines whether or not borderless collective printing is to be done based on the result of determination.

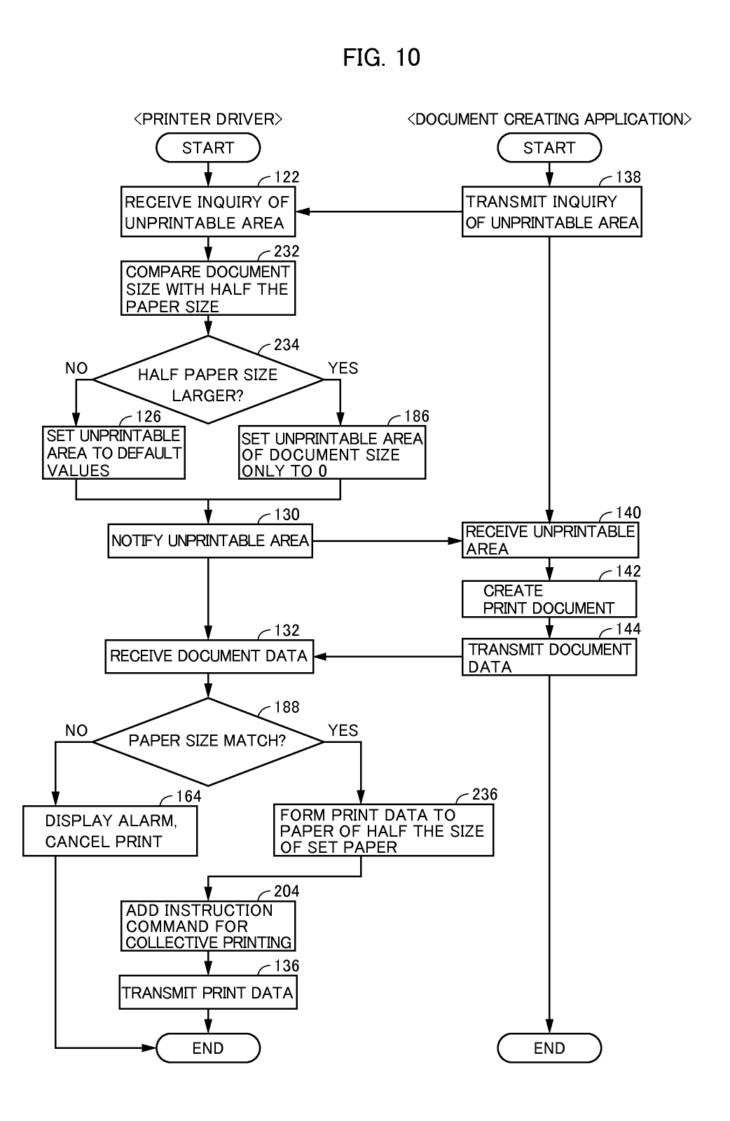

Though the flowchart shown in FIG. 10 is similar to that of FIG. 9, it is different in that it includes, in place of step 124 of the printer driver program shown in FIG. 9, a step 232, following step 122, of comparing the already set paper size of document data with half the already set output paper size, a step 234, following step 232, of branching the control flow depending on whether or not half the output paper size is larger than the paper size of the document data, and, in place of step 222 of FIG. 9, a step 186, executed if the determination at step 234 is positive, of setting the values of only the unprintable area of the already set document paper size to 0. If the determination at step 234 is negative, the control proceeds to step 126.

The flowchart of FIG. 10 is further different from that of FIG. 9 in that it includes, in place of step 224 of FIG. 9, a step 188 of determining whether or not the paper size of the document data received at step 132 matches the document paper size set in advance in the printer driver and branching the control flow depending on the result of determination, and a step 236, executed if the determination at step 188 is positive, of forming print data in half the output paper size set in advance in the printer driver, and passing the control to step 204.

At step 232 of FIG. 10, the printer driver compares the paper size of document data set in advance in the printer driver with half the size of output paper set in advance in the printer driver. Specifically, it compares the size of a sheet obtained by cutting the output sheet set in the printer driver along a line connecting midpoints of two opposite longer sides, with the paper size of the document data. At step 234, control is branched based on the result of comparison at step 232. That is, if half the size of already set output paper is larger than the already set paper size of the document data, at step 186, the values of unprintable area are set to 0 only for this paper size of the document. Otherwise, at step 126, default values of unprintable area are set for the paper size of each document. These values are transmitted to the document creating application at step 130. Therefore, setting for borderless printing is possible on the document creating application only when the result of determination at step 234 is YES.

Receiving the document data from the document creating application, the printer driver determines whether or not the paper size of the received document matches the paper size of the document set in advance in the printer driver. If the two match, the control proceeds to step 236. At step 236, print data is formed on paper half the size of output paper set in advance in the printer driver, an instruction command for collective printing is added to the print data at step 204, and the print data is transmitted to the printing device at step 136.

Therefore, according to the present embodiment, the output paper size and the document paper size are stored in advance in the printer driver, and if half the output paper size is larger, setting of borderless collective printing becomes possible. Thus, borderless collective printing is possible without using the large size print flag.

### Ninth Embodiment

The present embodiment is characterized in that upon reception of an inquiry related to the unprintable area from the document creating application, if the document paper size is the same as or smaller than the paper size of printing paper, the printer driver sends a notice that setting should be done to have the paper size of printing paper larger than the document paper size, and that if the dimensions of unprintable area are different from default dimensions set in advance on the side of document creating application, the printer driver sends a notice about that fact.

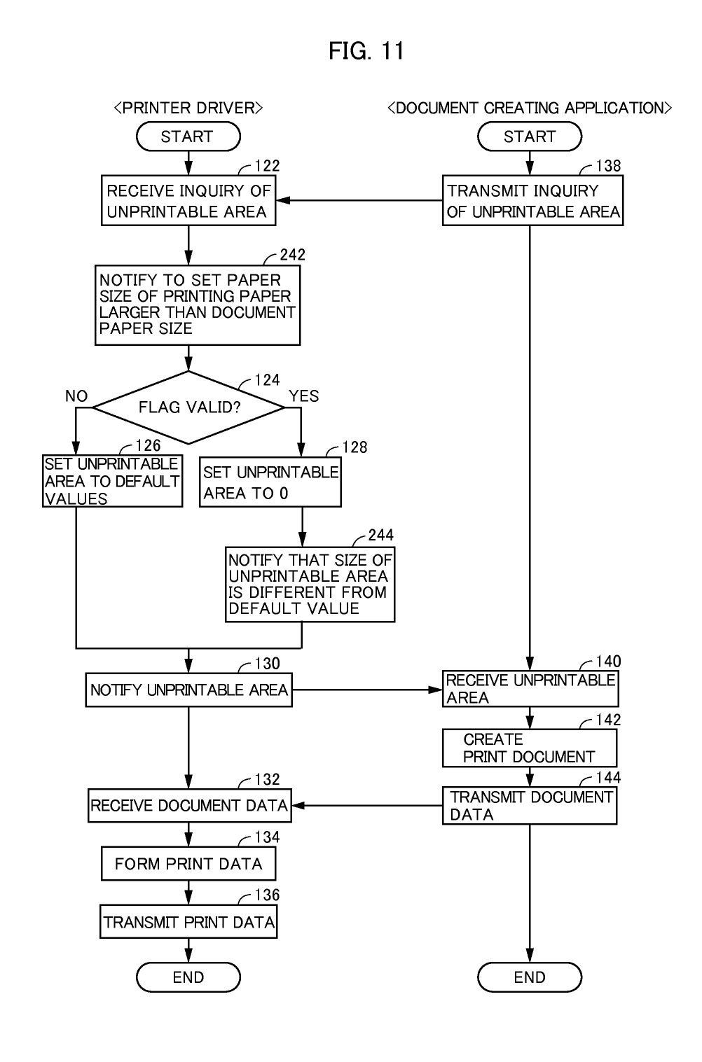

When compared with the flowchart shown in FIG. 3, the flowchart shown in FIG. 11 is different in that it includes a step 242 of giving a notice to the user that the paper size of printing paper should be made larger than the document paper size, if the document paper size is the same as or smaller than the paper size of the printing paper, and a step 244 of giving a notice to the user that the values of unprintable area are set to 0 at step 128.

In response to reception of an inquiry related to the unprintable area from the document creating application at step 122, at step 242, if the paper size of printing paper is the same as or smaller than the document paper size, a notice image (not shown) urging the user to set the paper size of printing paper to be larger is displayed. If the paper size of printing paper has already been set to be larger than the document paper size, no process is done at step 242, and the control proceeds to step 124.

In response to setting of values of unprintable area to 0 at step 128, at step 244, a notice is given to the user that the dimensions of unprintable area are different from the default values set in advance on the side of document creating application.

According to the present embodiment, since the user is urged to reset the paper size at step 242, printing error can be reduced. Further, since the user is notified that the dimensions of unprintable area are different from the default values, printing not intended by the user can be prevented.

As to the notice given at step 244, the timing of notification may be changed depending on the type of document creating application. The printer driver can determine the type of document creating application from the inquiry received at step 122. If the document creating application is of the type that allows edition of document data on an area other than the unprintable area, it is desired that step 244 is inserted following step 128, so that the user can grasp the size of unprintable area before edition. If the document creating application is of the type that does not allow edition of document data on an area other than the unprintable area, it is desired that step 244 is inserted following step 134 so that the user can grasp the size of unprintable area before the start of printing.

Though collective printing is done in the fifth to eighth embodiments, layout for collective printing may be done either by the printer driver or the printing device. Naturally, the user can directly operate to prepare the layout through printer interface 70.

Though an example of collective printing in which two documents are printed on one sheet of output paper has been described in the fifth to eighth embodiments, any number of documents can be printed on a sheet of output paper.

Though an example in which the prescribed value of unprintable area is set to 0 has been described in the embodiments above, the present invention is not limited to such embodiments. The prescribed value may be any value smaller than the default value. The prescribed value is, preferably, 0, as described in the embodiments above. If the prescribed value is set to 0, setting is such that there is no unprintable area at all. If the document as a whole is within the sheet of output paper without any unprintable area, the document can be printed on the sheet of printing paper without any missing portion. Therefore, in this case also, borderless printing is possible.

Though an example in which an instruction command related to collective printing is added to the formed print data (step 204) has been described in the fifth to eighth embodiments above, the collective printing also encompasses printing for saddle stitching. Therefore, the embodiments mentioned above may be configured such that an instruction command for saddle stitch printing is added to the formed print data.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A print controller used connected to a document data creating unit and to a printing device, comprising:
an unprintable area setting unit, responsive to reception of an inquiry related to dimensions of unprintable area as an area not allowing printing provided around a sheet of print paper from said document data creating unit, for selectively executing a process for setting dimensions of said unprintable area of output paper having larger size than paper size of a document created by said document data creating unit to default values, and a process for setting the dimensions to values smaller than the default values;
a notifying unit for giving a notice to said document data creating unit about the dimensions of said unprintable area set by said unprintable area setting unit; and
a print instruction unit for forming print data based on data related to the document received from the document data creating unit and on the values of dimensions of unprintable area, and instructing said printing device to print the print data.

2. The print controller according to claim 1, wherein said unprintable area setting unit includes
a flag storage unit for storing a flag indicating whether or not output to output paper larger than paper size of the document created by said document data creating unit is prohibited or permitted, and
a setting process selecting unit, responsive to reception of an inquiry related to the dimensions of unprintable area from said document data creating unit, for selectively executing a process for setting the dimensions of said unprintable area to said default values and a process for setting the dimensions to said prescribed values, based on a value of the flag stored in said flag storage unit.

3. The print controller according to claim 1, wherein said unprintable area setting unit includes
a determining unit for determining, based on data related to said document, whether or not paper size of said output paper is larger than paper size of said document, and
a setting process selecting unit for selectively executing a process for setting the dimensions of said unprintable area to said default values and a process for setting the dimensions to said prescribed values, based on a result of determination by said determining unit.

4. The print controller according to claim 1, further comprising
a collective printing instruction unit for adding an instruction command to execute collective printing, to a print instruction given by said print instruction unit; wherein
said unprintable area setting unit includes
a determining unit for determining whether or not paper size of the output paper is larger than paper size of a plurality of documents arranged side by side, based on the data related to said document, and
a setting process selecting unit for selectively executing a process for setting the dimensions of said unprintable area to said default values and a process for setting the dimensions to said prescribed values, based on a result of determination by said determining unit.

5. A communication device used connected to an external printing device, comprising:
a document data creating unit; and
the print controller according to claim 1 connected to said document data creating unit and said printing device.

6. A method of print control, for controlling, in a process of forming print data on output paper based on data related to a document created by a document creating application, on said data related to the document, comprising the steps of:
receiving, from said document creating application, an inquiry related to dimensions of an unprintable area not allowing printing of the document, provided around printing paper;
selectively executing the step of setting dimensions of said unprintable area of output paper having larger size than the paper size of said document to default values and the step of setting the dimensions to values smaller than the default values;
returning the dimensions of said unprintable area to said document creating application; and
transmitting print data formed based on already set dimensions of said unprintable area and on said data related to the document, to a printing device.
